(19) United States
(12) Patent Application Publication
(10) Pub. No.: US 2002/0094746 A1
(43) Pub. Date: Jul. 18, 2002

(54) Blowing doll

(76) Inventor: Amos Harlev, Kefar Truman (IL)

Correspondence Address: BILL POLKINGHORN DISCOVERY DISPATCH, 9003 FLORIN WAY, UPPER MARLBORO, MD, 20772, US

(21) Appl. No.: 09/761,729

(22) Filed: Jan. 18, 2001

(51) Int. Cl. A63H 33/00; A63H 3/00; F04B 17/03; A23L 1/025

(52) U.S. Cl. 446/178; 446/268; 99/517; 417/321; 417/572

(57) ABSTRACT

A figure toy having a head with a mouth and eyes mounted on a torso, the figure toy including a mechanism for expelling a flow of air from the mouth. This mechanism consists of an electric motor-driven blower mounted within the torso, an electronic controller operatively connected to the blower for activating and deactivating it, a power supply operatively connected to the blower and controller, and a sensing device designed and configured such that upon triggering, the sensing device provides a signal to the electronic controller for the purpose of activating and deactivating the blower. The figure toy can include a lamp for illuminating the eyes. The power supply and electronic controller can be mounted inside the figure toy. Sensing devices can be based on an LED emitter/receiver, ultrasonic detection, infrared detection, a directly-contacted microswitch, noise detection, verbal command recognition, temperature sensing, relative humidity sensing, or motion detection.

### FIELD AND BACKGROUND OF THE INVENTION

The present invention relates to figure toys, more particularly dolls and such toys in the form of a doll embodying a mechanism whereby a characteristic of a living being can be simulated.

There are various known U.S. patents in which a figure toy, more particularly a doll, has a mechanism in it whereby some characteristic or quality of a living being can be simulated. Reference is made to the following U.S. patents: U.S. Pat. Nos. 3,924,351: 4,244,139; 4,995,844; 3,195,269; and 3,234,688, and European Patent EP 79198.

It is the primary object of the present invention to provide a figure toy or doll which interactively simulates particular characteristics or qualities of a living being, namely the ability to expel air from the mouth of the figure toy or doll, accompanied by other physical effects including flashing lights and vocal sounds, when stimulated by bringing near the mouth of the figure toy or doll an object such as hot food or a hot beverage. The expulsion of air results in cooling of the hot food or beverage, as would be desired prior to the partaking thereof by the user of the inventive doll. This function provides hygienic benefits, in that blowing of air from the mouth of another person is avoided. In addition, the expulsion of air can be accompanied by other physical effects such as flashing eyes and vocal sounds. Thus, the use of the figure toy or doll provides the function of interactively facilitating, and making more enjoyable, the partaking of the food or beverage by the user, usually, but not exclusively, a child.

The prior art is lacking in disclosure of a figure toy or doll having a unique capability of simulating the quality or characteristic present in the herein invention

There is therefore a recognized need for and it would be highly advantageous to have a figure toy or doll capable of providing the blowing function which interactively facilitates, and makes more enjoyable, the partaking of hot food or a hot beverage.

### SUMMARY OF THE INVENTION

According to the teachings of the present invention there is provided an interactive figure toy or doll which is capable of expelling a flow of air from its mouth when stimulated by the passage near its mouth of an object such as hot food or a hot beverage, for the purpose of cooling the hot food or hot beverage.

According to yet another aspect of the present invention there is provided an interactive figure toy or doll which is capable of providing flashing lights and vocal sounds to accompany the expulsion of air.

The means for producing a flow of air from the mouth includes an electric motor-driven blower of suitable capacity, with its air outlet port connected to the inside of the mouth of the figure toy or doll. The blower motor is powered by a power source such as a battery pack typically mounted in the torso, but can also be energized by AC line current. The blower motor is activated and deactivated by an electronic controller typically mounted inside the torso which receives signals from a sensor mounted inside and/or outside the torso which senses the presence or approach towards the figure toy of objects, preferably, not food and hot beverages. Other physical effects, namely flashing eyes in one embodiment of the invention, and vocal sounds, are activated by the electronic controller concurrently with activation of the blower motor.

The present invention successfully addresses the shortcomings of the existing technologies by providing a figure toy or doll which is capable of producing a flow of air accompanied by physical effects such as flashing eyes and vocal sounds when activated by the user by means of effecting the approach of an object, preferably hot food or a hot beverage, to the figure toy or doll, thereby cooling the hot food or hot beverage and interactively facilitating, and making more enjoyable, the partaking by the user of hot foods or hot beverages.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a sectional side view schematically showing a view of the blowing doll comprising on embodiment of the invention;

FIG. 2 is a schematic diagram showing the electronic control and power supply circuit used in on embodiment of the invention.

### DESCRIPTION OF THE PREFERRED EMBODIMENTS

The present invention is a figure toy or doll in which is mounted an electrically powered blower connected by a flexible tube to an air nozzle mounted inside the mouth. When actuated by the user by the placing of a physical object, preferably hot food or a hot beverage, in the vicinity of the mouth of the figure toy or doll, such that a sensor mounted on the torso is activated, the electronic circuitry activates the electrically-powered blower. Activation of the blower causes room air to be drawn by the blower mounted in the torso of the figure toy or doll, conveyed through the flexible tube by the blower, and expelled through a nozzle at the mouth of the figure toy or doll. The blower is disengaged by the electronic controller when the aforementioned object is removed from the vicinity of the mouth of the figure toy or doll, deactivating the aforementioned sensor. In one embodiment of the invention, the sensor consists of an LED light emitter and receiver pair mounted on a line between the mouth and base of the figure toy or doll, which provides a signal to the electronic controller when the light path between the emitter and receiver is physically blocked, such as would occur when the aforementioned object is brought near the mouth of the figure toy or doll.

The principles and operation of the blowing figure toy or doll according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

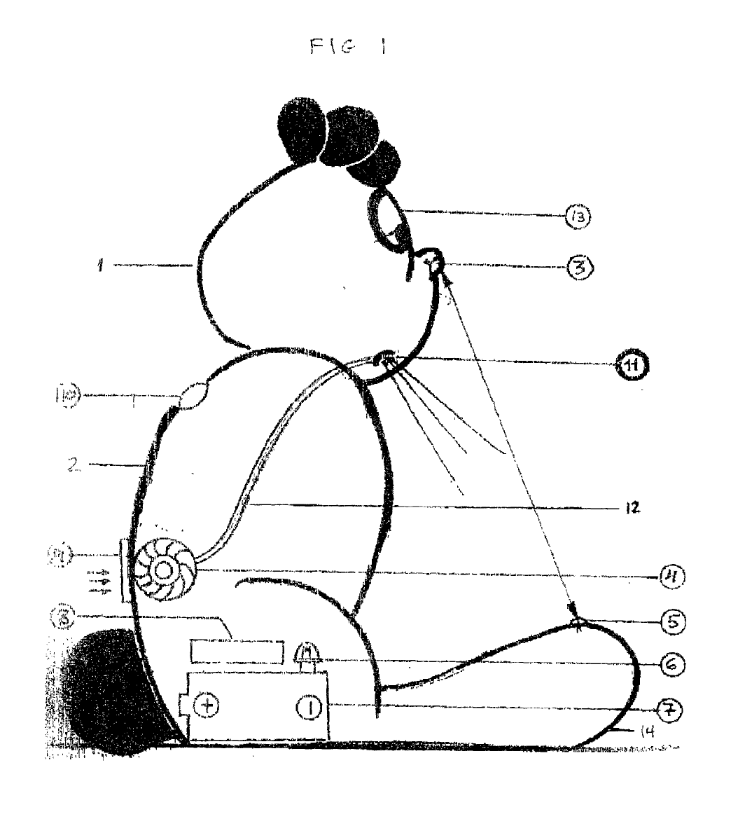

Referring now to the drawings, FIG. 1 illustrates one form of the apparatus constructed in accordance with the present invention. As shown in FIG. 1, one embodiment of the invention described herein consists of a figure toy or doll having a head 1 and torso 2 including a base 14 in the form of legs, and transparent simulated eyes 13. The air flow system mounted within the figure toy consists of an air inlet port 9 installed in the rear of the torso 2, an electric motor driven blower 4 mounted in the torso 2, an air flow connection tube 12, and a nozzle 11 connected to the inside of a port in the head 1 which is configured to simulate the mouth of the figure toy or doll. The electronic apparatus disposed within the torso 2 consists of a lamp 6, a power source 7, such as a battery pack or AC-powered DC power supply, an electronic controller 8, and a on/off push-button 10. Mounted at the lower part of the nose is the sensor 3, which, in one embodiment of the invention, is the emitter of a LED sensor set, and mounted on the upper surface of the base 14 is the receiver 5 of the LED sensor set.

In one embodiment of the invention, actuation of the on/off push-button 10 results in the application of electrical power to electronic controller 8, energizing LED emitter 3, and LED receiver 5, thereby resulting in the emission of light from the LED emitter 3 which is received by LED light receiver 5. When the light transmission path between LED emitter 3 and LED receiver 5 is physically blocked by an object such as hot food or a hot beverage, receiver 5 sends a signal to electronic controller 8, which closes and energizes the circuit powering electrical motor driven blower 4. Air is drawn by electric motor driven blower 4 through air inlet port 9 and is exhausted from electric motor driven blower 4 to flexible air flow connection tube 12 and nozzle 11. The air is expelled from the figure toy through nozzle 11. Preferably, lamp 6 is simultaneously activated, illuminating the inside of the torso 2 and resulting in the physical effect of flashing eyes.

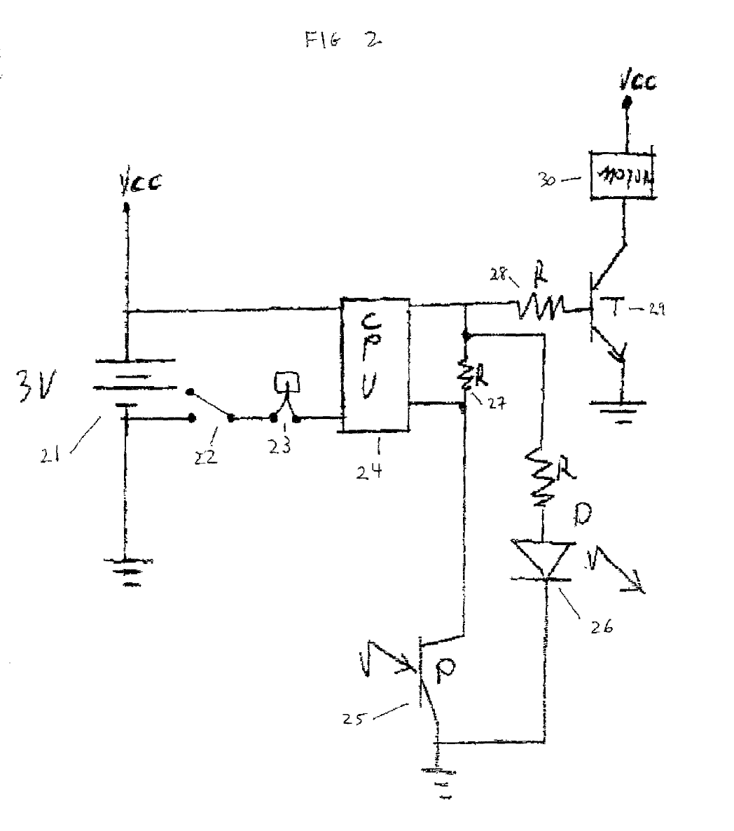

FIG. 2 is a schematic circuit diagram of the electronic controller comprising one embodiment of the invention in which an LED emitter and receiver are used to detect the approach of objects such as hot food or a hot beverage. Referring now to FIG. 2, the electronic controller consists of a voltage source 21, switch 22, lamp 6, CPU 24, photo transistor 25, photo diode 26, switching transistor 29, blower motor 30 and resistors 27, 28 and 29. When switch 22 is closed, voltage is applied to the terminals of CPU 24, which energizes photo transistor 25 and photo diode 26. Application of voltage to photo diode 26 causes light to be emitted from photo diode 26, mounted under the nose, and to be received by photo transistor 25, mounted on the base 14 of the figure toy.

In the embodiment of the invention described above, the functional elements of light emitter 3 and receiver 5 shown in FIG. 1 consist of photo diode 26 and photo transistor 25, both of which are shown in FIG. 2.

Reception of light by photo transistor 25 causes a zero voltage state at the emitter of photo transistor 25, which when sensed by CPU 24, results in a zero voltage signal at the output terminal of CPU 24 and at the base of switching transistor 29. In the presence of a zero voltage signal at the base of switching transistor 29, the emitter and collector of switching transistor 29 are disconnected. This results in an open circuit in which blower motor 30 and lamp 6 are connected. Thus, blower motor 30 and lamp 6 are inoperative in this condition.

When the light transmission path between light emitting diode 26 and photo transistor 25 is physically blocked by the presence of an object such as hot food or a hot beverage, no LED light radiaiton is received by photo transistor 25. In this condition, a voltage signal is emitted from photo transistor 25 to CPU 24, resulting in the transmission by CPU 24 of an output voltage signal to the base of switching transistor 29. The presence of a voltage signal at the base of switching transistor 29 results in the connection of the emitter and collector of switching transistor 29, effecting connection to ground and completion of the blower motor/lamp power circuit, resulting in the activation of blower motor 30 and the illumination of lamp 6. When engaged by blower motor 30, blower 4 draws room air through inlet port 9 and conveys it through the flexible air flow connection tube 12 to nozzle 11, which directs the flow of air to an exit port located in the mouth of the doll. Concurrently, lamp 6 is activated, illuminating the inside of the torso 2 and resulting in the physical effect of flashing eyes.

Subsequently, when the aforementioned object is withdrawn from close proximity of the doll, such that the light transmission path between light emitting diode 26 and photo transistor 25 is no longer interrupted, light radiation is again received by photo transistor 25. In this condition, as described above, the states of photo transistor 25 , CPU 24, and switching transistor 29 result in the disconnection of lamp 6 and blower motor 30 from ground. Thus, lamp 6 is extinguished and blower motor 30 is deactivated.

In continuous operation, as long as switch 22 is closed, lamp is illuminated and blower motor 30 activated, engaging blower 4, each time an object is brought near the figure toy or doll in a manner that physically blocks the light path between emitter 3 and receiver 5. Similarly, lamp 6 is extinguished and blower motor 30 deactivated, disengaging blower 4 when the object is removed from the light path between the emitter 3 and receiver 5.

In the above description of one preferred embodiment of the invention, the combination of light emitting diode 26 and photo transistor 25 in the electronic control circuit provides the means for sensing the presence of an object near the doll and for signaling CPU 24 to provide a voltage to the base of switching transistor 29, which results in the illumination of lamp 6 and the activation of blower motor 30.

In general, sensor 3, disposed in the vicinity of the nose of the figure toy, is a device which is capable of providing a suitable signal to CPU 24 when activated by the approach of the aforementioned object to the mouth area of the figure toy or doll. In one further preferred embodiment of the invention, sensor 3 is an ultrasound sensing device capable of providing suitable signal to CPU 24 when an object such as hot food or a hot beverage approaches the doll.

In a further preferred embodiment of the invention, sensor 3 is an infrared sensing device capable of providing a suitable output signal to CPU 24 when an object such as hot food or a hot beverage approaches the doll.

In a further preferred embodiment of the invention, sensor 3 is a microswitch that completes a circuit capable of providing a suitable output signal to CPU 24 when an object such as hot food or a hot beverage makes physical contact with and effects the closure thereof.

In a further preferred embodiment of the invention, sensor 3 is a sound sensing device capable of providing a suitable output signal to CPU 24 when a sound or noise is produced by the user.

In a further preferred embodiment of the ivnention, sensor 3 is a device capable of providing a suitable output signal to CPU 24 in response to voice activation of the sensor by verbal command recognition.

In a further preferred embodiment of the invention, sensor 3 is a device capable of providing a suitable output signal to CPU 24 based on measurement by the sensor of the difference in temperature between a reference temperature and the temperature of a hot object.

In a further preferred embodiment of the invention, sensor 3 is a device capable of providing a suitable output signal to CPU 24 based on measurement by the sensor of a change in the relative humidity of the surrounding air.

In a further preferred embodiment of the invention, sensor 3 is a device capable of providing a suitable output signal to CPU 24 based on detection of motion in the proximity of the doll mouth

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference In addition, citation or identification of any reference in this application shall not be construed as an admission that such reference is available as prior art to the present invention.

What is claimed is:

1. A figure toy having a head with a mouth and eyes mounted on a torso, the figure toy comprising.
(a) a mechanism for expelling a flow of air from the mouth, including:
(i) an electric motor-driven blower mounted within the torso;
(ii) an electronic controller operatively connected to said blower for activating and deactivating said blower, and
(iii) a power supply operatively connected to said blower and to said controller, and
(b) a sensing device designed and configured such that upon triggering, said sensing device provides a signal to said controller for the purpose of activating and deactivating said blower.

2. The figure toy of claim 1, further including a lamp for illuminating the eyes.

3. The figure toy of claim 1, wherein said electronic controller is mounted inside the torso of the figure toy.

4. The figure toy of claim 1, wherein said power supply is mounted inside the figure toy

5. The figure toy of claim 1, wherein said sensing device is designed and configured to be triggered when an object is brought near the mouth of the figure toy.

6. The figure toy of claim 1, wherein said sensing device is a light receptor designed and configured to provide all output signal upon sensing an object by a physical interruption of a path between a light emitter and a receptor.

7. The figure toy of claim 1, wherein said sensing device is an ultrasonic device designed and configured to provide an output signal upon sensing an object by ultrasonic detection.

8. The figure toy of claim 1, wherein said sensing device is an infrared detection device designed and configured to provide an output signal upon sensing the movement or presence of an object by infrared detection.

9. The figure toy of claim 1, wherein said sensing device is a microswitch designed and configured to provide an output signal when activated by direct mechanical contact with an object.

10. The figure toy of claim 1, wherein said sensing device is a noise detection device designed and configured to provide an output signal in response to audible noise.

11. The figure toy of claim 1, wherein said sensing device is a voice activated device designed and configured to provide an output signal in response to voice activation of the sensor by verbal command recognition.

12. The figure toy of claim 1, wherein said sensing device is a temperature measurement device designed and configured to provide an output signal based on the measurement by the sensor of the difference in temperature between a reference temperature and the temperature of an object.

13. The figure toy of claim 1, wherein said sensing device is a relative humidity measurement device designed and configured to provide an output signal based on measurement by the sensor of changes in relative humidity of the surrounding air.

14. The figure toy of claim 1, wherein such sensing device is a motion detector designed and configured to provide an output signal upon detection of the motion of an object in the vicinity of the sensor.
